(19) United States
(12) Patent Application Publication
(10) Pub. No.: US 2012/0324200 A1
(43) Pub. Date: Dec. 20, 2012

(54) METHOD AND APPARATUS OF MEMORY OVERLOAD CONTROL

(75) Inventors: Li Li, Beijing (CN); Ju Wei Shi, Beijing (CN); Wen Jie Wang, Shanghai (CN); Bo Yang, Beijing (CN)

(73) Assignee: International Business Machines Corporation, Armonk, NY (US)

(21) Appl. No.: 13/568,259

(22) Filed: Aug. 7, 2012

Related U.S. Application Data
(63) Continuation of application No. 13/360,839, filed on Jan. 30, 2012.

(30) Foreign Application Priority Data
Jan. 30, 2011 (CN) 201110035178.6

(51) Int. Cl. G06F 12/06

(52) U.S. Cl. 711/170; 711/E12.009

(57) ABSTRACT

A computer-implemented method, system, apparatus, and article of manufacture for memory overload management. The method includes: collecting memory application information of at least one node of a computer system that is implementing the method; predicting a memory overload period and an overload memory size of a first node where memory overload will occur based on the memory application information; and scheduling a memory space according to the memory overload period and the overload memory size.

### CROSS-REFERENCE TO RELATED APPLICATIONS

This application is a Continuation of and claims priority from U.S. application Ser. No. 13/360,839 filed on Jan. 30, 2012, which in turn claims priority under 35 U.S.C. §119 to Chinese Patent Application No. 201110035178.6 filed Jan. 30, 2011, the entire contents of both applications are incorporated herein by reference.

### BACKGROUND OF THE INVENTION

1. Field of the Invention

The invention relates to a memory management method and apparatus thereof. More particularly, the invention relates to a method and apparatus of memory overload control.

2. Description of the Related Art

In an application service environment, an application server may crash once the growing memory of applications reaches maximum heap size, and memory overload becomes a key challenge in memory management.

In the prior art, when it is predicted that memory overload will happen, garbage collection (GC) will be employed to provide some free memory; however, garbage collection itself also needs to consume a large amount of system resource. When heap utilization is high, frequent garbage collection often leads to serious consequences. Moreover, when heap utilization reaches a certain threshold, memory overload can not be avoided even if garbage collection is frequently performed.

In the prior art, another common method of memory overload management is that, when it is predicted that memory overload will happen, incoming request is dropped without being processed so as to reduce memory consumption caused by applications; the defect of this method is that request that should be processed is dropped and quality of service is sacrificed.

### SUMMARY OF THE INVENTION

The present invention provides a computer-implemented method, system, apparatus, and article of manufacture for performing memory management according to predicted parameters on memory overload.

According to an aspect of the present invention, a computer-implemented method is provided for memory overload management on a computer system which includes at least one node. The method includes: collecting memory application information of the at least one node; predicting a memory overload period and an overload memory size of a first node where memory overload will occur based on the memory application information; and scheduling a memory space according to the memory overload period and the overload memory size.

According to another aspect of the present invention, a computer system is provided for memory overload management. The computer system includes at least one node and further includes:

a memory information collecting and controlling means; and

a memory management controller;

wherein the memory information collecting and controlling means is configured to: (i) collect memory application information of the at least one node and (ii) send the memory application information to a memory management controller; and

wherein the memory management controller is configured to: (i) predict a first node where memory overload will occur based on the memory application information; (ii) calculate a memory overload period and an overload memory size of the first node; and (iii) schedule memory space according to the memory overload period and the overload memory size.

According to a further aspect of the present invention, a memory information collecting and controlling apparatus is implemented in a computer system that includes at least one node. The memory information collecting and controlling apparatus is coupled to the at least one node and is configured to: (i) collect memory application information of the at least one node and (ii) send the memory application information to a memory overload management controller. The memory overload management controller is configured to: (i) predict a first node where memory overload will occur; (ii) calculate a memory overload period and an overload memory size of the first node; and (iii) schedule memory space according to the memory overload period and the overload memory size.

According to still another aspect of the present invention, a memory overload controlling apparatus is implemented in a computer system that includes at least one node. The memory overload controlling apparatus is configured to: (i) predict a first node where memory overload will occur based on memory application information of the at least one node, (ii) calculate a memory overload period and an overload memory size of the first node, and (iii) issue a memory space schedule instruction according to the memory overload period and the overload memory size for scheduling memory space.

According to yet another aspect of the present invention, an article of manufacture tangibly embodying computer readable instructions which, when implemented, causes a computer system to carry out the steps of the method of the present invention.

### BRIEF DESCRIPTION OF THE DRAWINGS

These and other features of the invention will be more apparent from accompanied detailed description and drawings, in which:

FIG. 1 shows a flowchart of a method of memory overload management according to an embodiment of the present invention;

FIG. 2 shows a flowchart of an improved memory space schedule method according to an embodiment of the present invention;

FIG. 3 shows a flowchart of a method of predicting overload period T and overload memory size R according to an embodiment of the present invention;

FIG. 4 shows an example of performing linear fitting by using a least square method according to an embodiment of the present invention;

FIG. 5 shows mapping memory load profile according to the fitting relation according to an embodiment of the present invention;

FIG. 6 shows a schematic diagram of combining overload wave peaks and determining memory overload size R according to an embodiment of the present invention;

FIG. 7 shows a schematic diagram of determining migrating destinations according to an embodiment of the present invention;

FIG. 8 shows a structure diagram of a system for memory overload management according to an embodiment of the present invention;

FIG. 9 shows a node where Websphere XD is applied according to an embodiment of the present invention.

### DETAILED DESCRIPTION OF THE PREFERRED EMBODIMENTS

As will be appreciated by one skilled in the art, the present invention can be embodied as a system, method or computer program product. Accordingly, the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, the present invention can take the form of a computer program product embodied in any tangible medium of expression having computer usable program code embodied in the medium.

A combination of one or more computer usable or computer readable medium(s) can be utilized. The computer-usable or computer-readable medium can be, for example but not limited to, an electronic, magnetic, optical, electromagnetic, infrared, or semiconductor system, apparatus, device, or propagation medium, or any proper combinations thereof. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device or a proper combination thereof. In the context of this document, a computer-usable or computer-readable medium can be a tangible medium that can contain, or store the program for use by or in connection with the instruction execution system, apparatus, or device.

A computer readable signal medium can include a propagated data signal with the computer-usable program code embodied therewith, either in baseband or as part of a carrier wave. Such propagated signal can use a proper form, including but not limited to, electromagnetic, optical, or a proper combination. Computer readable signal medium can be a computer readable medium that is different from a computer-readable storage medium and can communicate, propagate, or transport the program for use by or in connection with the instruction execution system, apparatus, or device.

Program code included in the computer readable medium can be transmitted using an appropriate medium, including but not limited to wireless, wireline, optical fiber cable, RF, etc. or a proper combination thereof.

The computer program code for carrying out operations of the embodiments of the present invention can be written in a combination of one or more programming languages, including an object oriented programming language such as Java, Smalltalk, C++ or the like and conventional procedural programming languages, such as “C” programming language or similar programming languages. The program code can execute entirely on a user computer, partly on a user computer, as a stand-alone software package, partly on user computer and partly on a remote computer or entirely on a remote computer or server. In the latter scenario, the remote computer can be connected to the user computer through a type of network, including a local area network (LAN) or a wide area network (WAN), or the connection can be made to an external computer (for example, through the Internet using an Internet Service Provider).

Below, the embodiments of the present invention will be described with reference to flowcharts and/or block diagram of methods, apparatuses (systems) and computer program products. Note that, each block of the flowcharts and/or block diagrams, and combinations of blocks in the flowcharts and/or block diagrams, can be implemented by computer program instructions. These computer program instructions can be provided to a processor of a general-purpose computer, a special-purpose computer or other programmable data processing apparatus to produce a machine, such that the instructions which execute on the computer or other programmable data processing apparatus create means for implementing the functions/actions specified in the block(s) of the flowchart and/or block diagram.

These computer program instructions can also be stored in a computer-readable medium that can direct a computer or other programmable data processing apparatus to function in a particular manner, such that the instructions stored in the computer-readable medium produce an article of manufacture including instruction means which implement the functions/actions specified in the block(s) of the flowchart and/or block diagram.

The computer program instructions can also be loaded into a computer or other programmable data processing apparatus to perform a series of operational steps on the computer or other programmable data processing apparatus so as to produce computer implemented process, such that the instructions which execute on the computer or other programmable data processing apparatus will provide process for implementing the functions/actions specified in the block(s) of the flowchart and/or block diagram.

Next, the detailed embodiments of the present invention will be described in conjunction with drawings.

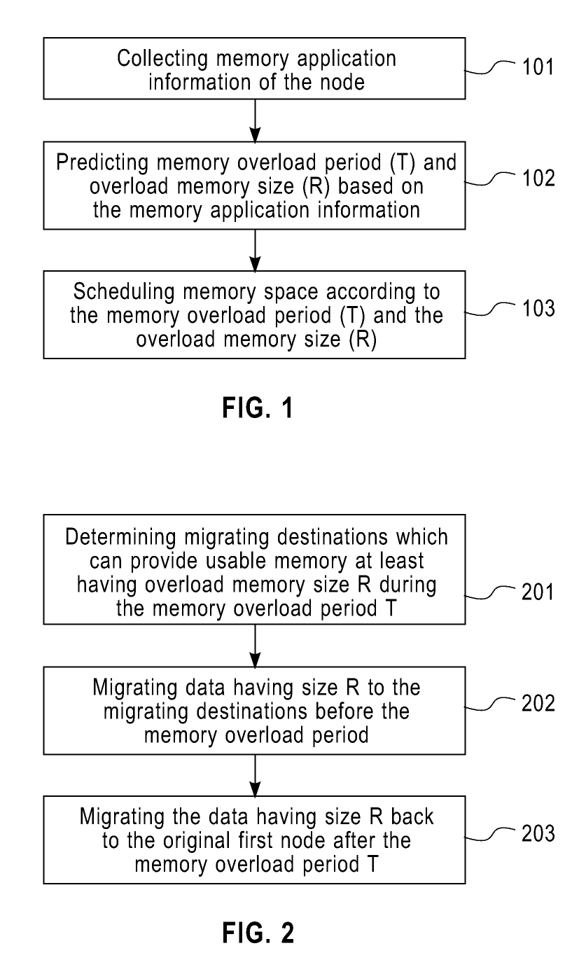

FIG. 1 is a flowchart of a method of memory overload management according to an embodiment of the present invention.

The method flow related to the embodiment of the present invention can be applied in a computer system including at least one node, particularly, in an example, in a cluster including at least one node. The method includes: collecting memory application information of the at least one node; predicting a memory overload period and an overload memory size of a first node where memory overload will happen based on the memory application information; and scheduling a memory space according to the memory overload period and the overload memory size.

In step 101, memory application information of the node is collected. Memory application information can be information for predicting memory overload period (T) and overload memory size (R), can include request arrival rate and required memory at corresponding time, in which the request arrival rate refers to the number of service requests made to a node in unit time, and it is the number of requests sent to an application server when the node is an application server. The required memory is memory utilization state of a node. In this step, memory application information can be collected periodically or non-periodically.

In step 102, a memory overload period (T) and an overload memory size (R) of a first node where memory overload will occur are predicted based on the collected memory application information.

In this step, the memory overload period (T) is a time period during which memory overload will occur, and includes at least one time period during which memory overload has occurred. The overload memory size (R) is a size of out of memory in the period during which memory overload occurs. Optionally, a determining step can further be added in this step, only when it is predicted that memory overload will occur, then will memory overload period (T) and overload memory size (R) be predicted; if memory overload will not occur, the method returns to step 101.

In step 103, a memory space is scheduled according to the memory overload period and the overload memory size. Preferably, sufficient memory space can be scheduled through the process of this step. Even if the result of memory space schedule does not necessarily provide sufficient memory space, the number of the dropped memory service requests can be reduced in some extent or adverse impact due to memory overload will be lowered in some extent, so as to process a node service request that will cause memory overload at the first node. Traditional memory overload management method can only determine whether overload will occur according to a preset threshold. Since memory actually provided by a node cannot exceed that node's maximum memory, performing memory load profile analysis through actually detected record is not feasible, specific parameters of memory overload (in particular, duration of overload, size of overload memory) ca not be determined. Thus it is impossible in the prior art to perform memory overload management according to specific parameters of memory overload.

One of the important improvements in the embodiment is to perform more purposeful memory space schedule according to specific parameters of memory overload, such that services requests that will cause memory overload at the first node can be processed, processing of these services requests will consume memory of the node.

The detailed implementation of scheduling memory space in step 103 can employ the manner in the art, for example, GC can be performed in advance to prepare sufficient memory space for processing node service requests at peak time. Alternatively, sufficient memory space can be prepared by using backup storage device in advance.

Although memory overload management has been improved in some extent by combining step 102 with existing memory space schedule technology as a full solution, the processing of GC will still affect node operation or additional memory device is still needed. Thus, memory space schedule in step 103 can also employ a memory space schedule method that is improved relative to the prior manner, and the memory space schedule method related to FIG. 2 described next is an alternative approach which can realize further improvement and provide more efficient overload memory management.

FIG. 2 shows a flowchart of an improved memory space schedule method of step 103 in FIG. 1, including steps 201 to 203.

In step 201, data migrating destinations including at least one second node are determined, the migrating destinations can at least provide available memory at least having the overload memory size (R) during the memory overload period (T). In this step, the available memory required by the first node can either be provided solely by one second node, or be provided collectively by a plurality of second nodes, that is, each second node contributes available memory having different size according to specific condition. However, it should be assured that the sum of the available memory provided by respective second node is at least equal to the memory required by the first node to prevent overload.

In step 202, migration data in the first node having the overload memory size (R) is migrated to the migrating destinations before the memory overload period (T).

In practice, a migration instruction is issued according to T, R and migrating destination information, for migrating migration data in the first node having the overload memory size (R) to the migrating destinations before the memory overload period (T).

In one example, memory data that is not required urgently can be migrated to an idle server as replica data, for example; the data that is not required urgently is determined by those skilled in the art according to the actual condition. By predicting overload memory size (R) and memory overload period (T) as well as space and time interval of corresponding idle resource, the data that is not required urgently is migrated to a selected idle node. Idle resource in the system can be utilized to increase service capacity of an overloaded server. “Idle” refers to data that is considered to be not required urgently due to the history profile of each traffic load varies with time.

Both primary data and replica data may cause memory overload. Thus, in another embodiment of the present invention, the primary data can also be migrated, especially in some cases, when there is no replica data but only has primary data, migration can still be performed. Requests are redirected to the migrated node for processing, data in memory also needs to be migrated and runtime logic of application server is also migrated. Meanwhile, the request allocation system at foreground is notified of such change, so that the redirected requests can be processed.

In step 203, after completion of the memory overload period (T), the migration data is restored to the first node by the target node. This step is optional.

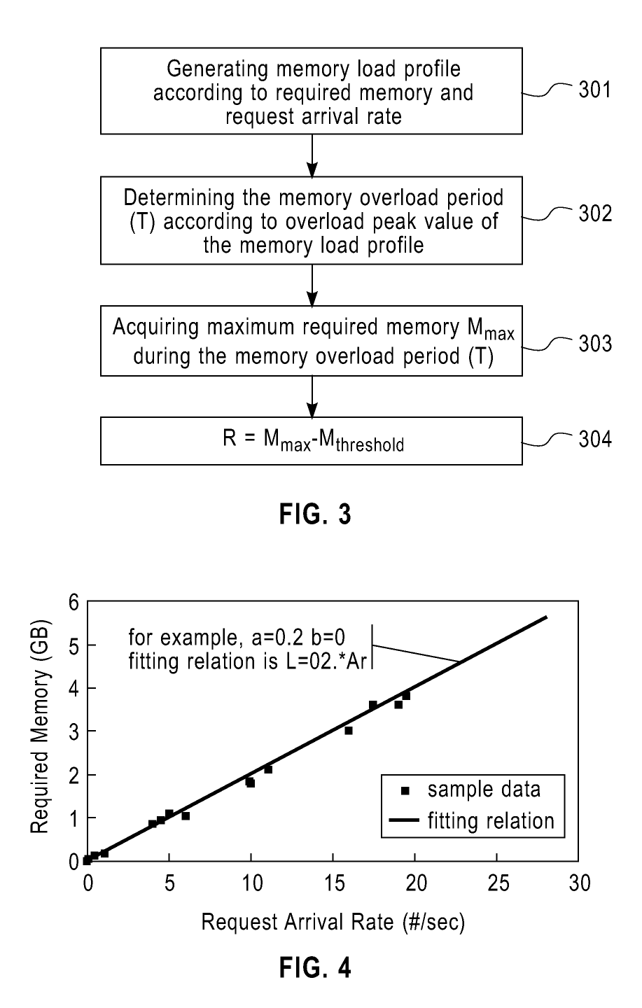

FIG. 3 shows an example of predicting overload period T in FIG. 1 (i.e. step 102). Step 102 in FIG. 1 can include steps 301 to 302.

In step 301, complete memory load profile is generated according to the history data of required memory and request arrival rate.

History data can only record part of actually occurred memory load profile, and cannot provide a complete load profile including out of memory load. In an embodiment of the present invention, a complete memory load profile is elaborately generated through association relationship between request arrival rate and required memory, that is, association relationship between memory load L and arrival rate Ar is calculated: Ar, L=f(Ar), so as to obtain complete memory load profile including the time when memory overload occurs.

In the embodiment of the present invention shown in FIG. 4, association relationship can be calculated by determining fitting relation by using linear regression, that is, L and Ar are in linear relationship: L=a*Ar+b, undetermined coefficients a and b will be determined. Specifically, in this embodiment of the present invention, a horizontal coordinate represents request arrival rate and refers to the number of requests arrived in unit time; and a vertical coordinate represents required memory. Thus each sample data point represents correspondence relationship between request arrival rate and real required memory. Further, linear fitting can be achieved by using least square method to determine undetermined coefficients a and b, in the example shown in the figure, a=0.2, b=0.

In calculating association relationship, all conditions can be fitted and processed by using linear regression; for some special conditions, a basic effect can be achieved by applying linear regression while a better effect can be achieved by applying nonlinear regression. For instance, in one example, for several requests in the same session, what is issued by a first request can be a write operation and memory is occupied. However, what gets triggered by several subsequent requests are reading operations, reading data written into memory by the first request, so the several subsequent requests will not occupy memory in the same ratio as that of the first request, thus they are in nonlinear relationship. In this case, the effect of a nonlinear fitting will be better than that of a linear fitting.

Further, in one example, linear fitting and nonlinear fitting can also be performed simultaneously, variance is used as metric for evaluating two solutions, and the fitting solution with smaller variance will be selected to perform mapping.

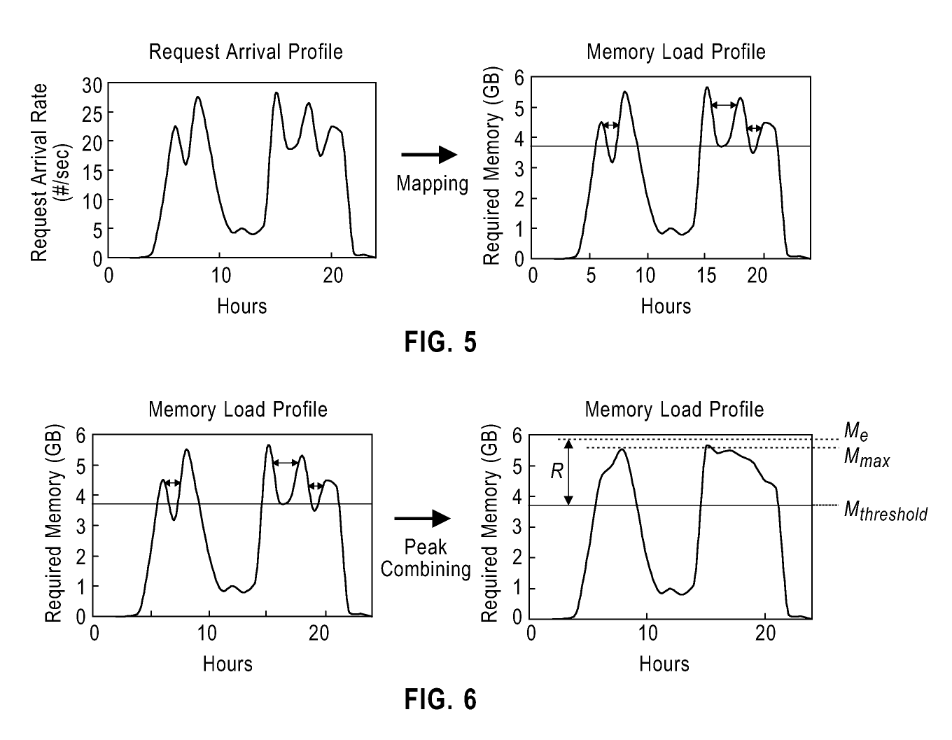

Referring to FIG. 5, with the above method flow, complete memory load profile can be figured out according to a mapping relationship fitted from the history data of both the request arrival rate and required memory. The memory load profile can exist in form of data file, and those skilled in the art can flexibly set its storage location. The memory load profile can be used to calculate memory overload period (T) and overload memory size (R) in subsequent steps, and can also be used to determine migrating destinations in subsequent steps.

The memory load profile can be generated periodically or non-periodically, or be generated as needed. Generally, it is generated offline by gathering statistics about memory application information during a period of time. In one example, by applying information collected in step 101, a profile curve of each node service is generated in an offline manner, such as statistics about the recent 10 weeks, and for Monday, Tuesday, Wednesday, Thursday, Friday, one profile curve is given for each of them. Alternatively, a profile curve is collectively given without considering what day is it in a week.

In step 302, the memory overload period (T) is determined according to the overload peak value of the memory load profile.

If the memory load profile is generated offline in advance, it is invoked when overload occurs to predict T and R. It can be generated as needed in an online manner according to stored memory application information.

First, a peak period during which out of memory will occur is determined, a memory threshold M_{threshold} can be set, and the part in the memory load profile exceeding this threshold is just the part that memory overload will occur.

Referring to FIG. 6, in one embodiment of the present invention, if the interval between two peak periods is smaller than a preset threshold Tᵢₙₜₑᵣᵥₐₗ, they are combined so as to form the curve shown in the right side, which can avoid frequent load migration. Those skilled in the art can determine the value of Tᵢₙₜₑᵣᵥₐₗ based on the specific condition.

Then, the duration of overload is predicted according to duration of peak value exceeding the memory overload threshold M_{threshold}.

Next, the embodiment of the present invention for predicting overload memory size (R) of step 102 shown in FIG. 1 will be further described. Step 102 of FIG. 1 can further include steps 303 to 304.

In step 303, the maximum required memory Mₘₐₓ during the memory overload period (T) is acquired through comparison.

In step 304, referring to the schematic diagram of determining overload memory size (R) shown in FIG. 6, let R=M_{Max}−M_{threshold}. In another embodiment of the present invention, prediction error Me can also be considered, i.e., R=Mₘₐₓ−M_{threshold}+Mₑ.

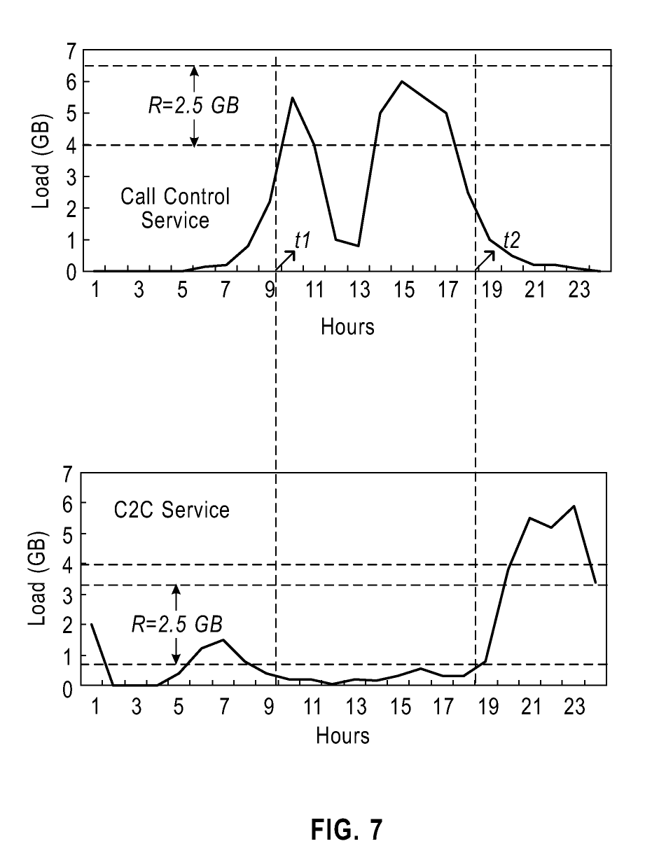

FIG. 7 illustrates how to determine migrating destinations by taking two specific nodes for example, so as to help to explain step 202 in FIG. 2.

In one embodiment of the present invention, a first node is mainly used to process call control service, and has a memory load profile shown on the top of FIG. 7. Since peak of communication generally occurs on duty time, peak will occur in the period during morning and afternoon.

In one embodiment of the present invention, a second node is mainly used to process C2C (Click to call) service and has a memory load profile shown on the bottom of FIG. 7. The reason for this is the peak of the service is generally at off duty; thus the peak of memory load profile occurs in the period during night. The memory load profiles of the two have different time profile features, and the embodied daily life custom is only for illustration rather than for limiting the application. Nodes of processing different applications due to various reasons can have different memory load profiles, all of which can bring space for optimizing memory control.

In the embodiment of the present invention shown in FIG. 7, the detailed implementation of step 202 is as follows. A first node responsible for call control service has memory overload at time t1, and the memory overload period T is 9 hours and memory overload size R is 2.5 GB. According to this analysis result, the second node responsible for C2C service is a competent migrating destination, that is, the second node will have 2.5 GB free memory in the 9 hours during which overload occurs at the first node. Further, the second node can perform migration before time t1, and transmit 2.5 GB of replica data to Node B. Migration time can be appropriately ahead of the time at which overload actually occurs, and those skilled in the art can choose migration time according to actual situation so as to have sufficient time for performing migration.

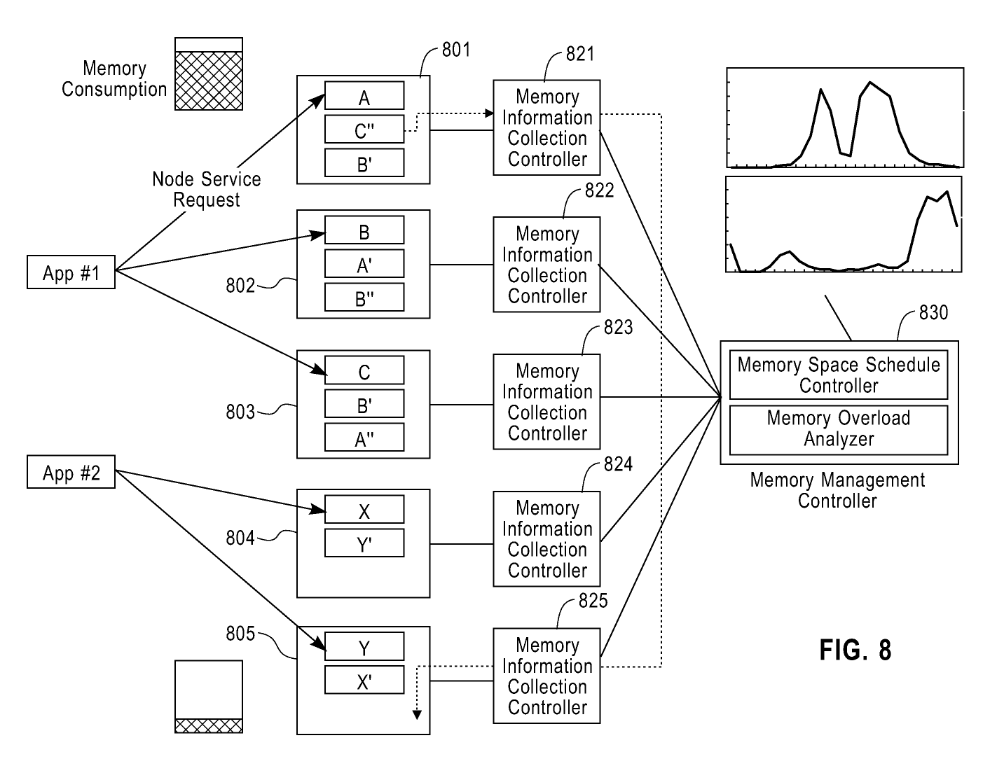

FIG. 8 is a structure diagram of a system for memory overload management according to an embodiment of the present invention. The system includes a plurality of nodes 801-805, a plurality of memory information collecting and controlling means 811-812, and a memory management controller 830. The system can be used to solve the problem that overload occurs periodically in node during node service request peak time.

The memory information collecting and controlling means 801-805 are coupled to respective nodes 801-805 and are configured to collect memory application information of the coupled nodes and send the information to the memory management controller 830. Each memory information collecting and controlling means is a separate functional unit, and in practice, it can either be implemented by using means independent to the node, or be implemented by adding memory information collecting and controlling function in the node.

The memory management controller 830 is configured to perform memory management, to predict a first node where memory overload will occur in response to the memory application information and calculate memory overload period (T) and overload memory size (R) of the first node, and is also configured to schedule memory space according to the memory overload period and the overload memory size, so as to process service requests that will cause memory overload at the first node.

In one embodiment of the present invention, the function of the memory management controller 830 can be split into a plurality of sub-functional units, such as including an overload analyzer and a memory management controller; in which the overload analyzer predicts a first node where memory overload will occur in response to memory application information and calculates the memory overload period (T) and the overload memory size (R) of the first node. The overload analyzer can implement the flow of methods of calculating memory overload period and overload memory size in FIGS. 1 and 2. A memory space schedule controller performs memory space schedule according to the memory overload period and the overload memory size, so as to process the overloaded service requests.

As described above, prior art can be utilized to schedule sufficient memory to process overloaded node service requests, thereby forming a complete memory overload management system; however, there is still space for further improvement.

In the embodiment of the present invention shown in FIG. 8, the memory management controller 830 is further improved for implementing step S103 in FIG. 1, so as to apply a new memory space schedule solution, and determine migrating destinations including at least one second node other than the overloaded node. The migrating destinations can at least provide available memory at least having the overload memory size (R) during the memory overload period (T).

The above improved memory schedule can be applied in the case when primary data and replica data are provided, in which in order to guarantee reliability of primary data in a node, the primary data will be replicated to a memory replication system. Thus, if the node fails, the primary data can be completely restored such that the system can continue to work. This dispersion is a type of deployment for achieving high availability. In FIG. 8, primary A in node 801 has replica data A′ and A″ in nodes 802, 803, and other nodes also have similar storage manner. Here, it is to be noted that, storage manner of nodes shown in FIG. 8 is only for illustrating the improved memory space schedule controller, and there is no need to employ the storage manner of dispersing primary and replica data if memory space schedule controller employs conventional manner.

The memory space schedule controller determines a competent migrating destination, and the migrating destination only includes node 804, then issues an instruction for performing data migration before the memory overload period (T) and data sending, receiving modules perform data migration according to the instruction. Since data sending and receiving means are well-known technology in the art, details about implementation thereof will be omitted for brevity. It is to be noted that, the location of data sending and receiving means can be selected, i.e., can be set independently. In one example, when modules for sending, receiving data locate in the memory information collecting and controlling means, instruction for migrating data is sent to the memory information collecting and controlling means.

The information collecting and controlling means migrates migration data having at least the overload memory size (R) in the first node where overload occurs to the migrating destination before the memory overload period (T). For the embodiment of the present invention shown in FIG. 8, referring to the direction shown by dashed lines, replica data C″ in overloaded node 801 is migrated to the migrating destination 804.

Alternatively, the memory information collecting and controlling means move or restore the migration data back to the first node after the memory overload period (T). With profile-based solution, the selected destination node can also further avoid memory overload when the replica data is returned to the original node.

In an improved embodiment of the present invention, the memory application information includes a request arrival rate and a required memory, and the memory management controller 830 is also configured to calculate association relationship between the request arrival rate and the required memory according to history record of the two, and to further calculate memory load profile according to the association relationship. The specific solution can use the methods disclosed in FIG. 2, FIG. 3, and FIG. 4, and based on this, those skilled in the art can also calculate memory load profile offline or online in other means, such as in the memory information collecting and controlling means. The memory load profile is used for determining the memory overload period (T) and the overload memory size (R), or for determining the migrating destinations.

Based on FIGS. 1-7 and various method flows recorded in the description, those skilled in the art can implement them in the system shown in FIG. 8 without paying creative work, and thus how to implement the respective method steps in FIG. 8 will not be described one by one.

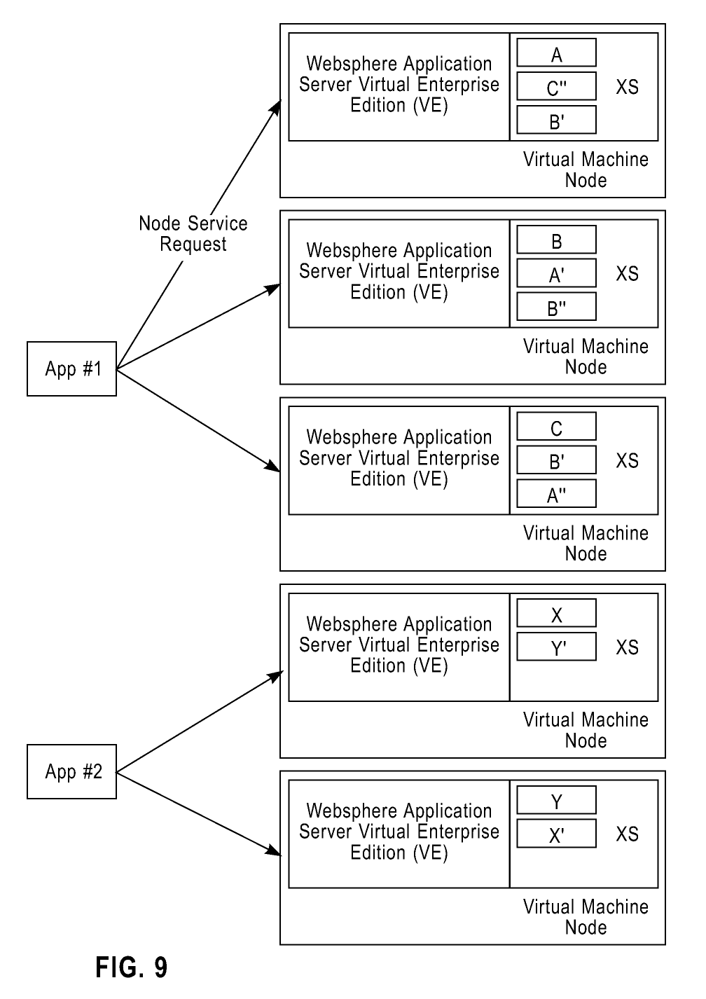

FIG. 9 shows an embodiment of a node, representing a schematic diagram of a system when IBM Corporation's WebSphere Extended Deployment (Websphere XD) is applied in the node.

WebSphere Extended Deployment (Websphere XD) includes two important components: VE (Virtual Enterprise) and XS (eXtreme Scale); in which VE is used to provide the ability of large scale application hosting and improve quality of service; and XS is a large scale memory replication system and can improve availability of VE. Specifically, in the embodiment of the present invention shown in FIG. 9, VE loaded in a node that functions as application server is runtime process logic of the application, and is responsible for processing application requests APP#1, APP#2 and the like.

In order to guarantee reliability of application data (i.e. primary data) of VE, the application data will be replicated to in-memory replication system; thus, in case there is any problem in VE, the application data can be completely restored so that the system can continue to work. XS achieves high availability (HA) by dispersion of primary and replica data. Each primary data has k corresponding replica shards in other server container, when primary data fails, its replica will immediately take over its job.

VE and XS can either be deployed on a virtual machine, or be deployed on a real computer; generally, one VE only serves one application.

Since the ratio of memory space composition of XS is preset, memory space composition of XS will not have any change even if memory overload occurs. Thus, when it is predicted that overload will occur, the node service request must be dropped; therefore the node shown in this figure can be used as a specific scenario for implementing the above technical solutions.

It is to be noted that, the embodiment of the present invention shown in FIG. 9 is not a limitation to the application. Whereas VE is only one type of application program virtual infrastructure, the application program virtual infrastructure is a platform providing application program virtualization; it is not an application server, rather, it runs on the application server for aggregating application servers into a grid or a virtualized environment. Based on the information disclosed in the embodiments of the present invention, other alternatives can also occur to those skilled in the art, such as, JBoss, Tomcat, BEA Weblogic etc. XS is also one type of In-Memory Replication System which can dynamically cache, partition, replicate and manage application data and service logic across a plurality of servers. Based on the information disclosed in the embodiments of the present invention, other alternatives can also occur to those skilled in the art, such as, Oracle Coherence, HStore, DynaCahe etc.

In the embodiment shown in FIG. 9, in an application server cluster using In-Memory Replication Technology, since a large amount of burst node service requests can cause memory overload, complementary memory resource in the application server cluster can be discovered by using the technical solutions related to FIGS. 1-8 to perform reasonable migration on resource, such that memory request that will be dropped in the art can be processed.

The flowcharts and block diagrams in FIGS. 1-9 illustrate the architecture, functionality, and operation of possible implementations of systems, methods and computer program products according to various embodiments of the present invention. In this regard, each block in the flowcharts or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As for the above teaching, there can be various modifications and variations to the embodiments of the present invention that are obvious to those skilled in the art. The scope of the present invention is defined by the appended claims.

1. A method of memory overload management, implemented in a computer system including at least one node, the method comprising:
collecting memory application information of the at least one node;
predicting a memory overload period and an overload memory size of a first node where memory overload will occur based on the memory application information; and
scheduling a memory space according to the memory overload period and the overload memory size.

2. The method according to claim 1, wherein scheduling memory space according to the memory overload period and the overload memory size comprises:
determining migrating destinations including at least one second node, wherein the migrating destinations provide available memory having a size that is at least as large as the overload memory size during the memory overload period; and
issuing a migration instruction for migrating migration data in the first node to the migrating destinations before the memory overload period, wherein the migrating migration data is at least as large as the overload memory size.

3. The method according to claim 2, further comprising:
restoring the migration data back to the first node after the memory overload period.

4. The method according to claim 2, wherein the migration data is replica data.

5. The method according to claim 2, further comprising:
redirecting a node service request that has been directed to the first node to the migrating destinations,
wherein the migration data is primary data of the first node.

6. The method according to claim 2, wherein:
the memory application information includes a request arrival rate and a required memory;
an association relationship between the request arrival rate and the required memory is determined according to a history record of the request arrival rate and the required memory; and
a memory load profile is determined according to the association relationship.

7. The method according to claim 6, wherein:
the memory overload period and the overload memory size are determined according to an overload peak value of the memory load profile.

8. The method according to claim 6, wherein the migrating destinations are determined according to an overload peak value of the memory load profile.

9. The method according to claim 7, wherein if the interval between two overload peak values is smaller than a preset time threshold, then wave peaks corresponding to the two overload peak values are combined.

10. The method according to claim 6, wherein:
a maximum required memory during the memory overload period is determined, and
the overload memory size is the difference between the maximum required memory and a memory overload threshold.

11-20. (canceled)

21. An article of manufacture tangibly embodying computer readable non-transitory instructions which, when implemented, cause a computer system to carry out the steps of the method of memory overload management according to claim 1.
